(19) United States
(12) Patent Application Publication
(10) Pub. No.: US 2026/0122201 A1
(43) Pub. Date: Apr. 30, 2026

(54) VIRTUAL CONFERENCE RECORDING TECHNIQUES

(71) Applicant: Zoom Video Communications, Inc., San Jose, CA (US)

(72) Inventors: Liangliang Deng, Hefei (CN); Zhiqing Li, Hefei (CN); Ye Wen, Hefei (CN); Kangbao Yin, Hefei (CN)

(73) Assignee: Zoom Video Communications, Inc., San Jose, CA (US)

(21) Appl. No.: 18/925,893

(22) Filed: Oct. 24, 2024

(51) Int. Cl. H04N 7/15; G10L 15/26

(52) U.S. Cl. CPC H04N 7/155; G10L 15/26

(57) ABSTRACT

In some implementations, the techniques may include detecting, by a computing device of a first service, a recording trigger that identifies a video conference of a second service that is to be recorded. The techniques may include communicating a first request for a recording client that is a client computing device of the first service that is capable of joining the video conference. The techniques may include receiving, from the recording client, a second request for video conference parameters that include information that corresponds to the video conference. Moreover, the techniques may include communicating the video conference parameters to the recording client, wherein the recording client is configured to join the video conference in response to the communicating. Also, the techniques may include receiving information identifying a status of the recording client. The techniques can include corresponding methods, computing devices, systems, and non-transitory computer readable storage mediums.

### FIELD

The present application generally relates to virtual conferences and more specifically relates to recording media streams during virtual conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 show example systems for recording during virtual conferences;

FIG. 4 shows a sequence diagram of a technique to enable a first conference provider to record a virtual conference of a second conference provider;

FIG. 5 shows a flow diagram of a technique to enable a first conference provider to record a virtual conference of a second conference provider; and

FIG. 6 shows an example computing device suitable for use with disclosed techniques.

### DETAILED DESCRIPTION

Examples are described herein in the context of recording during virtual conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items. The disclosed techniques can be implemented in corresponding methods, processes, systems, and devices. The techniques can also be implemented as computer program products and instructions stored on non-transitory computer readable media. The stored instructions can cause one or more processors to perform one or more operations of the disclosed techniques.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

During a virtual conference, participants may engage with each other to discuss any matters of interest. Typically such participants will interact in a virtual conference using a camera and microphone, which provides video streams and audio streams (each a “media” stream or a “multimedia” stream) that can be delivered to the other participants by the virtual conference provider and be displayed via the various client devices' displays or speakers.

Virtual conferences (also known as “video conferences”) may be used in a collaborative work environment. For example, a sales team may meet with sales clients via a virtual conference. A user may wish to record virtual conferences to memorialize a meeting. For example, a member of a sales team may record a sales meeting so that the team can review the meeting.

Conference participants may utilize multiple different virtual conference providers, and it may be desirable to access recordings for multiple providers through a single service. For example, a sales team may want recordings for every sales meeting, but the sales team may use different video conference providers with various sales clients. Each sales client may use a particular video conference provider internally, and the sales client may prefer to use their particular provider for meetings with the sales team. Accordingly, a first video conference provider can perform operations to record a meeting that is hosted by a second video conference provider.

A virtual conference provider (e.g., a video conference provider) may perform one or more operations on a recording of a conference from a second provider. For example, the virtual conference provider may transcribe speech from the conference's audio streams. The transcript can identify each speaker and the transcript's text may be timestamped so that conversations during the meeting can be reconstructed using the transcript (e.g., by identifying what was said, by whom, and when).

Natural language processing techniques can be performed on the transcript (or directly on the recording in some embodiments). For example, the natural language processing techniques can be used to identify filler words that were spoken during the conference. Filler words can be speech that is spoken occupy a pause in an utterance or conversation (e.g., “umm”). The transcript may be condensed or summarized by identifying and excising these filler words. Information about these filler words can be recorded for each speaker, and, for example, a rate of filler words can be recorded for speakers. A sales team can use the rate of filler words as a metric to evaluate team members'performances. Other metrics can be identified from a recording or transcript in various embodiments. These metrics can include talking speed, talk-listen ratio, speech segment length, question-answer delay, etc.

This illustrative example is given to introduce the reader to the general subject matter discussed herein and the disclosure is not limited to this example. The following sections describe various additional non-limiting examples and examples of providing real-time translation during virtual conferences

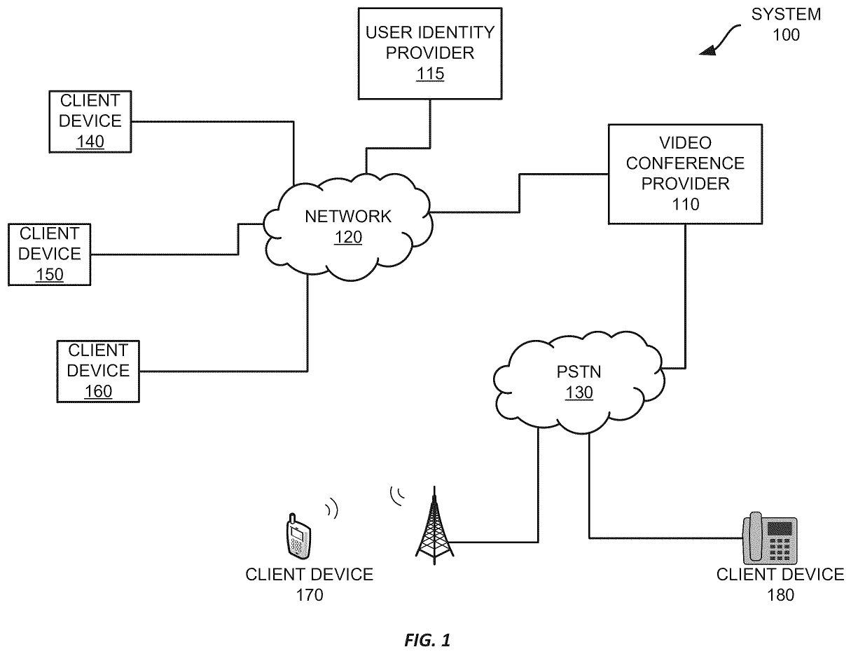

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity. In some instances, video conference provider 110 may provide a user profile language to video conference provider 210.

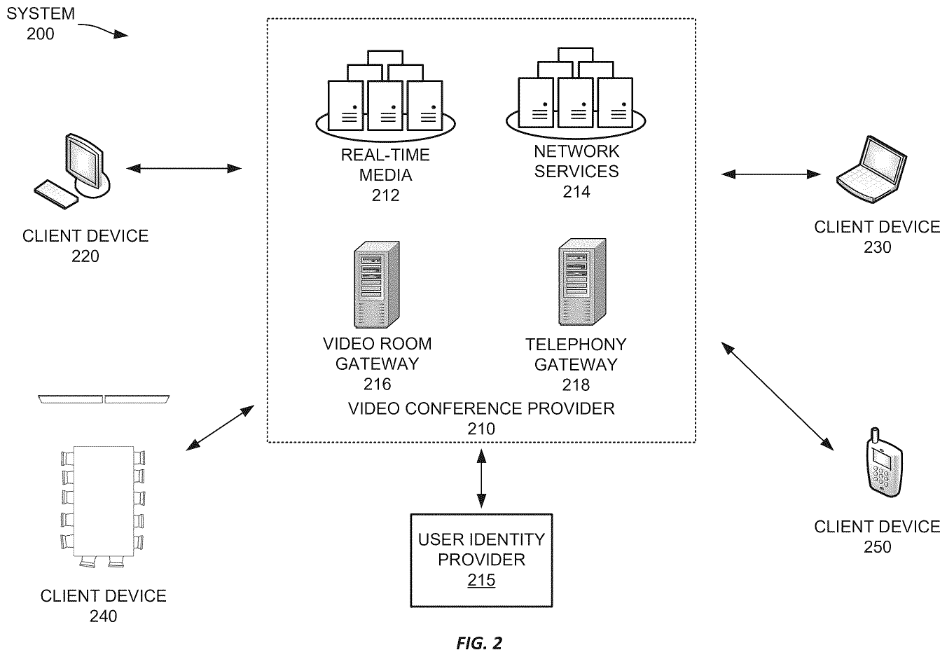

Video conference provider 110 allows clients to create video conference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common video conference may be used. Further, in some examples, and as alluded to above, a meeting may also have “breakout” rooms. Such breakout rooms may also be rooms that are associated with a “main” video conference room. Thus, participants in the main video conference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, a meeting language, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio streams or video streams for the meeting (and will stop transmitting audio streams or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information (e.g., a set of run parameters) that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively. The user identify provider 115 may provide a user profile language to the video conference provider 110.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video streams and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams (e.g., media streams). Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing. In some instances, the media stream may contain metadata indicating a language for the media stream or the client devices 220-250. The language may be a device language provided by software on the client device or a language selected by a user of the client device via a graphical user interface (GUI).

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, a meeting language, a source language or a target language for translation, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams. In some instances, the real-time media servers 212 may store a source language, target language, user profile language, meeting language, or identified language for the multimedia streams sent and received by the server.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices'participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture.

Some video conference providers may provide more or less functionality than described above and may not separate functionality into different types of servers as discussed above. Instead, any suitable servers and network architectures may be used according to different examples.

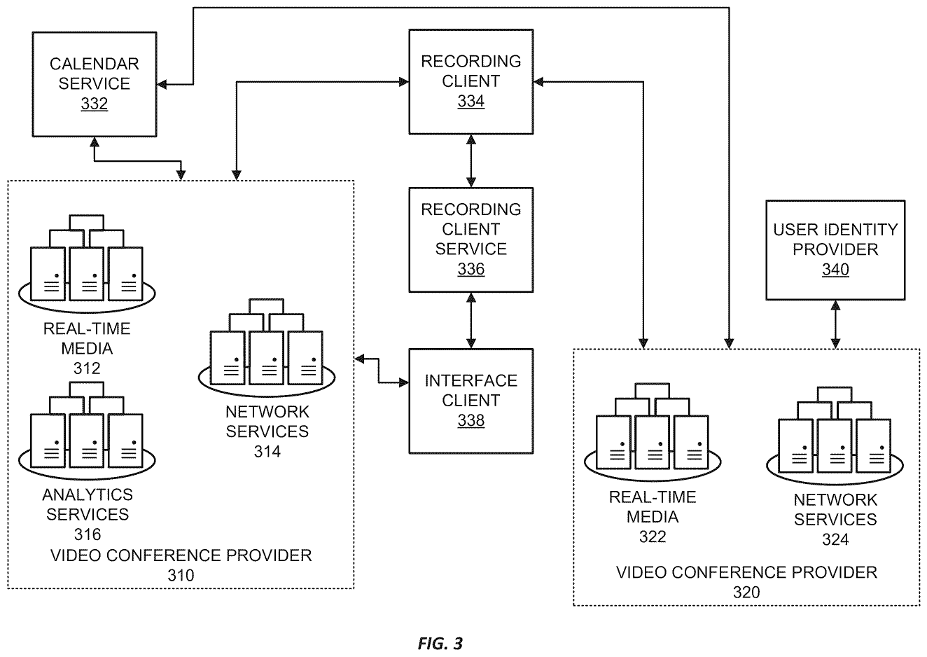

Referring now to FIG. 3, FIG. 3 shows an example system 300 for techniques to enable a first conference provider to record a virtual conference of a second conference provider according to various embodiments. Video conference provider 310 and video conference provider 320 are separate video conference providers that independently offer video conferencing functionality. The descriptions of the video conference providers in FIG. 1 and FIG. 2 can apply to both video conference provider 310 and video conference provider 320.

The analytics services servers 316 of the video conference provider 310 may generate metrics for recorded media streams. The media streams ingested by the analytics services servers 316 may be recordings of conferences hosted by any combination of the video conference provider 310 and the video conference provider 320 in various embodiments. Media streams from video conferences hosted by video conference provider 310 may be recorded by the real time media servers 312.

The analytics services servers 316 can generate metrics for a recorded video conference. The metrics can include information about human speech in the recordings. For example, the metrics can include the number of filler words for each speaker in the recording, talking speed, talk-listen ratio, speech segment length, question-answer delay, frequency of speaker changes, etc. Talking speed can be the number of words per minute that are spoken by a particular conference participant. The talk-listen ratio can be the ratio of time spent speaking and time spent not speaking for each participant in the conference. This ratio can be based on word count (e.g., words spoken by a participant/words spoken by other meeting participants) or time based (e.g., the time spent speaking by a participant/the time spent speaking by other participants). Speech segment length can be the length of time that a participant is speaking without an interruption by another participant, and an interruption can be speech by another participant that exceeds a time threshold. The speech segment length metric can be any combination of an average speech segment length and a longest speech segment length. The question-answer delay can be a time (or number of words) between a by a particular participant and a response by another participant. The frequency of speaker changes can be the rate at which the speaking participant changes.

The analytics services servers 316 can use one or more machine learning models to generate analytics. For example, the questions and answers that are used to calculate question-answer delay can be identified by a machine learning model that is trained to perform natural language processing tasks. The machine learning models can perform sentiment analysis to generate a sentiment score that indicates whether a participant's speech represents a positive or negative opinion. A low sentiment score may reflect that a participant dislikes a proposal, and a high sentiment score may reflect that the participant likes a proposal. The machine learning models may also perform engagement analysis to determine whether a participant is contributing to the conversation or the participant is distracted. The input to the machine learning models that is used to generate a particular metric can be any combination of the other metrics generated by the analytics service.

The analytics services servers 316 may aggregate metrics across multiple video conferences. For example, the analytics services servers 316 may assign an identifier for a conference participant that corresponds to each metric. The metrics can be used to evaluate the participant's performance. For example, an interviewee who is meeting with potential employers may use the metrics to evaluate the interviewee's performance during the interviews. The interviewee may review the metrics after successful, and unsuccessful interviews, to identify patterns in the metrics data that corresponds to each outcome. For example, the interviewee may determine that she is less likely to receive a follow-up interview if her speech is above 170 words per minute or below 130 words per minute.

The metrics may be associated with an identifier for the virtual conference or a group of virtual conferences, and the metrics can be aggregated across conferences. For example, a sales team may conduct a series of meetings with a particular sales lead (e.g., a prospective or current customer of a product being offered for sale by the sales team). The sales team may wish to use the metrics to evaluate trends across the series of meetings. For example, the sales team's supervisor may monitor the metrics for the team's meetings with a particular lead. The supervisor may decide whether she needs to attend the next meeting based on trends in the metrics. For example, the supervisor may decide that she will personally lead the next meeting because the sentiment score has been trending lower with each subsequent meeting.

The analytics services servers 316 of video conference provider 310 can record a virtual conference that is hosted by the video conference provider 320. For example, video conference provider 310 can interact with video conference provider 320 to record a video conference so that the analytics services servers 316 can generate metrics using the recording. Video conference provider 310 can initiate a recording in response to a notification that a participant, who has requested metrics, is scheduled to attend a video conference that is hosted by video conference provider 320. In some embodiments, a user can request a recording of a video conference hosted by video conference provider 320 via a graphical user interface of video conference provider 310 (e.g., by providing access information for the conference).

A notification can be provided to video conference provider 310 as an email from video conference provider 320. The network services servers 324 may provide an invitation email to the intended participants for a particular video conference. This invitation email may include access information that can be used to join the virtual conference, and the access information can include the conference's start time, end time, meeting access credentials (e.g., a password for the conference), and a meeting access address (e.g., a universal resources locator (URL) address). The invitation email for a conference hosted by video conference provider 320 can be generated by network services servers 324, and, to request a recording, a participant can provide the invitation email to an email address associated with network services 314 (e.g., by forwarding the invitation email or including the network services email address on the list of conference invitees).

A notification can be provided by a calendar service 332 in some embodiments. The calendar service 332 can be associated with video conference provider 310. For example, the calendar service 332 can be hosted by video conference provider 310 or the calendar service 332 can share information with video conference provider 310. For example, a participant who has an account with video conference provider 310 can grant permission for the provider to access the user's account with calendar service 332. Video conference provider 310 can periodically check the calendar service 332 for scheduled video conferences that are hosted by video conference provider 310 or the calendar service can provide information about any scheduled conferences to video conference provider 310.

Video conference provider 320 can automatically create an entry in a calendar hosted by the calendar service 332 in response to a scheduled video conference, and the entry can be a notification that triggers a recording. For example, the calendar service 332 can be associated with an email service. Video conference provider 320 may send an email to the email service in response to a newly scheduled video conference, and the calendar service 332 may create an entry for the conference in response to the email. This entry can be provided to video conference provider 310 by the calendar service 332 or the video conference provider 310 can detect the event through monitoring of the calendar service 332.

Video conference provider 310 can request a recording client 334 in response to a notification. The recording client 338 can be a client computing device that can execute client software of the video conference provider 320 so that the recording client can join and record a video conference. The recording client can be a bare metal machine, a virtual machine, or any computing device that can host the client software. In some embodiments, the recording client can be a containerized workload. A containerized workload can be application software (e.g., video conference client software) that is bundled with the files and libraries that are necessary to run the software. A containerized workload can execute on a wide variety of hardware and software configurations, and, for example, a containerized workload can execute on multiple different operating systems.

Recording clients, such as recording client 338, can be provisioned by a recording client service 336. Provisioning the recording client 338 can include creating a containerized workload and providing the containerized workload to a host computing device. The recording client service may schedule workloads, migrate workloads from a first host to a second host, or perform any other operations to ensure that a recording client 334 is available to join a virtual conference at the conference start time. Provisioning the recording client may include providing the recording client 334 with access information for the virtual conference that is to be recorded.

The recording client service 336 can provision the recording client in response to a request from video conference provider 310. The request can be received at the recording client service 336 via interface client 338. The interface client can be a web shell or any other interface that allows a server computer to be controlled using a web browser application. The request can include access information for a virtual conference that is to be recorded, or the recording client service 336 can retrieve the access information via the interface client 338. The access information can include cryptographic information that the recording client can use to join a conference hosted by virtual conference provider 320. For example, the access information can include any combination of public key(s), private key(s), and tokens that can be used to authenticate the recording client 334 (e.g., via Diffie-Helman Key Exchange). Any of the services described in this disclosure can be implemented as software, as hardware, or as a combination of software and hardware.

The recording client 334 can use the access information to join a virtual conference at the conference start time. For example, the recording client 334 can request access to the virtual conference by using an access link from the access information. The access link may correspond to a virtual conference that is hosted by network services 324. The recording client 334 may provide access credentials to video conference provider 320 (e.g., via an application programming interface that is exposed by network services 324), and the access credentials may be provided to the user identity provider 340 for an authentication decision. If recording client 334 is authorized, the client can join the virtual conference and the client can receive media streams from the real-time media servers 322. The recording client 334 can record some or all of the media streams and the recorded streams can be provided to the analytics service servers 316 and/or the real-time media servers 312. The recording client can provide status updates during the conference, and, after the conference concludes, the recording client can be deprovisioned by the recording client service 336.

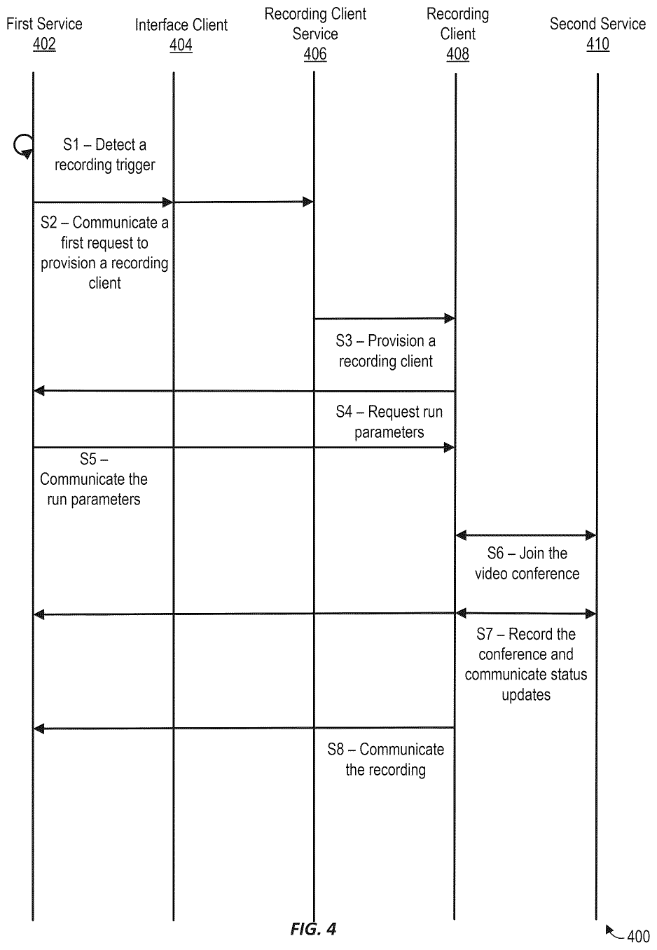

Referring now to FIG. 4, FIG. 4 shows sequence diagram 400 of a technique to enable a first conference provider to record a virtual conference of a second conference provider.

At S1, a first service can detect a recording trigger. The first service can be a virtual conference provider such as video conference provider 310, and the trigger can be a notification. For example, the trigger can be a meeting invitation email from second service 410. The second service 410 can be virtual conference provider 320 in various embodiments. Any virtual conference provider described in this disclosure can be the first service or the second service in various embodiments, and the first service for a particular conference can be the second service for a different virtual conference.

At S2, the first service 402 can communicate a first request to provision a recording client. The request can be communicated to a recording client service 406. For example, the request can be forwarded to the recording client service 406 via an interface client (e.g., interface client 338). The interface client can be any interface that allows a server to be remotely accessed (e.g., a web shell).

At S3, the recording client service 406 can provision a recording client 408. Provisioning a recording client 408 can include creating a containerized workload, providing the containerized workload to a computing device, and causing the computing device to execute the containerized workload. The containerized workload can include client software of the second service 410 and any libraries or software that are required to execute the client software.

At S4, the recording client 408 can request run parameters from the first service 402. The run parameters can include access information such as access credentials, a meeting access address, configuration settings, private keys, public keys, etc. The run parameters can be provided to the recording client 408 by the networks services servers of the first service 402.

At S5, the run parameters can be communicated from the first service 402 to the recording client 408. Communication between the first service 402 and the recording client 408 may occur via the interface client in some embodiments.

At S6, the recording client 408 can join the video conference that is hosted by the second service 410. The recording client may access the video conference by providing the access credentials to the second service.

At S7, the recording client 408 can record the virtual conference. The recording client 408 may need to request recording functionality from the second service 410 before recording the virtual conference. Status updates for the virtual conference can be communicated to the first service 402. The status updates can include: joined waiting room, joined conference, recording started, recording paused, recording ended, and conference ended.

At S8, the recording client 408 can communicate the recording to the first service 402. The recording client 408 may select some or all of the media streams from the conference and provide the media streams to the first service 402. The media streams may be multiplexed and/or compressed before the recordings are provided to the first service.

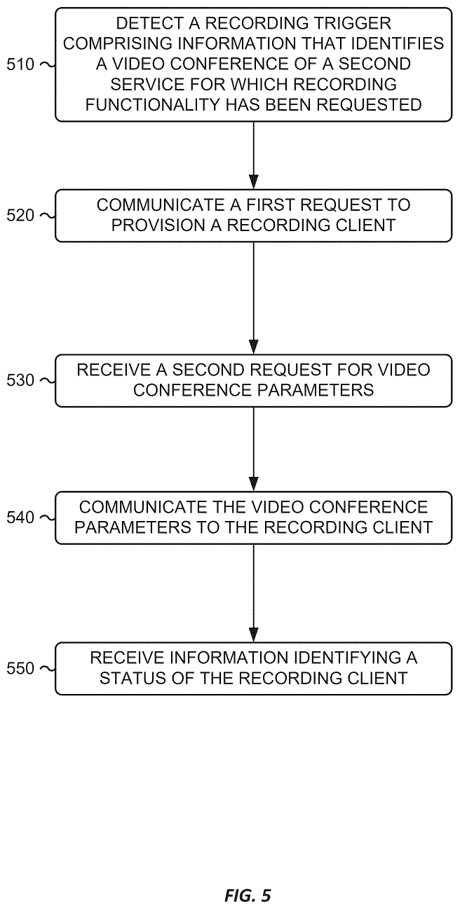

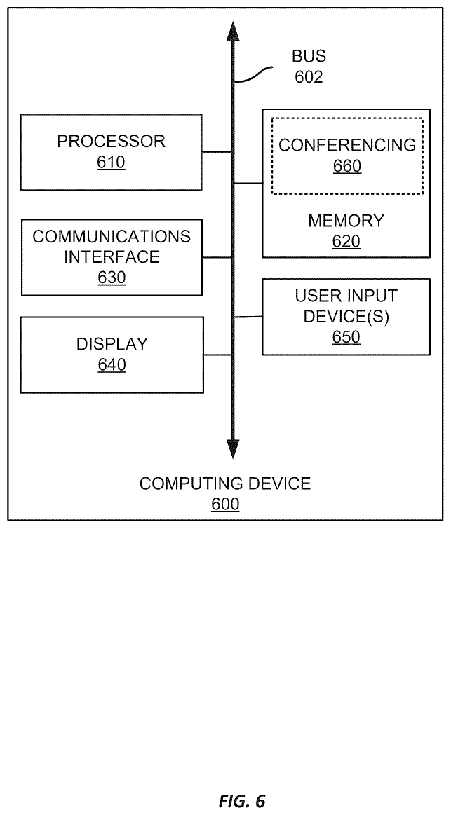

Referring now to FIG. 5, FIG. 5 shows an example method 500 to enable a first conference provider to record a virtual conference of a second conference provider. This example method 500 will be described with respect to the systems 100-300 shown in FIGS. 1-3, the sequence diagram 400 shown in FIG. 4, and the example machine learning model 600 shown in FIG. 6; however, any suitable systems according to this disclosure may be employed. The method can be implemented with corresponding devices, systems, computer program products, or non-transitory computer readable media.

At block 510, a recording trigger can be detected by a first service. The recording trigger can comprise information that identifies a video conference of a second service for which recoding functionality has been requested. The first service and the second service can be a virtual conference provider such as virtual conference provider 210, video conference provider 310, and virtual conference provider 320. The information that identifies the video conference can be access information such as an access link and an access credential.

At block 520, a first request to provision a recording client can be communicated. The first request can be communicated from the first service to a recording client service such as recording client service 336. The first request can be communicated to the recording client service via an interface client such as interface client 338.

At block 530, a second request for video conference parameters can be received. The second request can be received at the first service and from a recording client. The recording client (e.g. recording client 334) can be a containerized workload that is operable to join a virtual conference of the second service. The video conference parameters can be the access information from 510.

At block 540, the video conference parameters from 530 can be communicated to the recording client. The video conference parameters can be communicated to the recording client via the interface client and the recording client service in some embodiments.

At block 550, information identifying a status of the recording client can be received. The information can be communicated from the recording client to the first service. The information identifying the status can indicate whether the recording client has joined the virtual conference, whether the client has failed to join the conference, whether the client has begun recording, whether the client has paused recording, whether the client has concluded recording, and whether the conference has concluded.

A recording of the video conference from the recording client. The recording can be received by the computing device of the first service, and the recording can be stored as a stored recording. The video conference can be one of a plurality of video conferences that are associated with an event, and storing the recording can include associating the stored recording of the video conference with the event. Associating the stored recording with an event can include associating the recording with a unique identifier.

Metrics can be generated from the recordings. A recording may be used to generate a transcript, and the recording may be stored with the stored recording (e.g., associating the transcript and recording with the same identifier). Any combination of the recording and the transcript can be analyzed to identify metrics for at least one participant in the video conference. The metrics for each participant comprise one or more of a talking speed, a talk-listen ratio, a filler word rate, a maximum monologue length, and a question-answer delay. The metrics for the at least one participant can be stored.

A recording trigger can include receiving an email from a second service at a first service. The email can include access information that identifies the video conference and a start time for the video conference. The access information can be used to stored a recording trigger for the video conference. The recording trigger can be detected by the first service at the start time for the video conference.

Detecting the recording trigger can comprise monitoring a calendar of a user of the first service. The first service can detect an appointment in the calendar, and the appointment can identify the video conference and a start time for the video conference. The start time for the video conference can be stored as as the recording trigger for the video conference. The first service can detect the recording trigger at the start time for the video conference.

In some embodiments, recording parameters can comprise a recording client name, a recording client avatar, video conference credentials, an application programming interface (API) endpoint, and an application programming interface (API) access token.

The description of the example method 500 provides a particular ordering of functionality for purposes of illustration. However, it should be appreciated that virtual spaces are dynamic and operate asynchronously. Thus, as members interact with the virtual conference providers to request recoding functionality, the state of the virtual conference provider changes based on those interactions. And since the interactions may be driven by user selections or occur in response to user inputs, they may occur in any suitable ordering or any number of times. Thus, the method 500 illustrates functionality available within the space according to one example sequence of interactions with the virtual conference providers. In some examples, various steps may be performed in different orders or may be omitted.

Referring now to FIG. 6, FIG. 6 shows an example computing device 600 suitable for use in example systems or methods for recording during virtual conferences according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for recording during virtual conferences according to different examples, such as part or all of the example methods 500 described above with respect to FIG. 5. The computing device 600, in this example, also includes one or more user input devices 650, such as a keyboard, mouse, touchscreen, microphone, etc., to accept user input. The computing device 600 also includes a display 640 to provide visual output to a user.

In addition, the computing device 600 includes a video conferencing application 660 to enable a user to join and participate in one or more virtual spaces or in one or more conferences, such as a conventional conference or webinar, by receiving multimedia streams from a video conference provider, sending multimedia streams to the video conference provider, joining and leaving breakout rooms, creating video conference expos, etc., such as described throughout this disclosure, etc.

The computing device 600 also includes a communications interface 640. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method, comprising:
detecting, by a computing device of a first service, a recording trigger comprising information that identifies a video conference of a second service for which recording functionality has been requested;
communicating, by the computing device of the first service and to an interface client, a first request to provision a recording client, wherein the recording client is a client computing device of the first service that is capable of joining the video conference of the second service;
receiving, by the computing device of the first service and from the recording client, a second request for video conference parameters, wherein the video conference parameters comprise information that corresponds to the video conference of the second service;
communicating, by the computing device of the first service, the video conference parameters to the recording client, wherein the recording client is configured to join the video conference of the second service in response to the communicating;
receiving, by the computing device of the first service, information identifying a status of the recording client.

2. The method of claim 1, wherein the method further comprises:
receiving, by the computing device of the first service, a recording of the video conference from the recording client; and
storing, by the computing device of the first service, the recording of the video conference as a stored recording.

3. The method of claim 2, wherein the video conference is one of a plurality of video conferences that are associated with an event, and wherein the storing the recording of the video conference further comprises:
associating, by the computing device of the first service, the stored recording of the video conference with the event.

4. The method of claim 2, further comprising:
generating, by the computing device of the first service, a transcript of the recording of the video conference; and
storing, by the computing device of the first service, the transcript of the recording of the video conference.

5. The method of claim 4, further comprising:
analyzing, by the computing device, at least one of the recording and the transcript to identify metrics for at least one participant in the video conference, wherein the metrics for each participant comprise one or more of a talking speed, a talk-listen ratio, a filler word rate, a maximum monologue length, and a question-answer delay; and
storing, by the computing device, the metrics for the at least one participant.

6. The method of claim 1, wherein detecting the recording trigger comprises:
receiving, by the computing device of the first service, an email from the second service, wherein the email includes information that identifies the video conference and a start time for the video conference;
storing, by the computing device of the first service, the start time for the video conference as the recording trigger for the video conference; and
detecting, by the computing device of the first service, the recording trigger at the start time for the video conference.

7. The method of claim 1, wherein detecting the recording trigger comprises:
monitoring, by the computing device of the first service, a calendar of a user of the first service;
detecting, by the computing device of the first service, an appointment in the calendar, wherein the appointment identifies the video conference and a start time for the video conference;
storing, by the computing device of the first service, the start time for the video conference as the recording trigger for the video conference; and
detecting, by the computing device of the first service, the recording trigger at the start time for the video conference.

8. The method of claim 1, wherein the video conference parameters comprise a recording client name, a recording client avatar, video conference credentials, an application programming interface (API) endpoint, and an application programming interface (API) access token.

9. A non-transitory computer-readable medium storing a set of instructions, the set of instructions comprising:
one or more instructions that, when executed by one or more processors of a computing device, cause the computing device:
detect a recording trigger comprising information that identifies a video conference of a second service for which recording functionality has been requested;
communicate, to an interface client, a first request to provision a recording client, wherein the recording client is a client computing device of a first service that is capable of joining the video conference of the second service;
receive, from the recording client, a second request for video conference parameters, wherein the video conference parameters comprise information that corresponds to the video conference of the second service;
communicate the video conference parameters to the recording client, wherein the recording client is configured to join the video conference of the second service in response to the communicating;
receive information identifying a status of the recording client.

10. The non-transitory computer-readable medium of claim 9, wherein the one or more instructions cause the computing device to:
receive a recording of the video conference from the recording client; and
store the recording of the video conference as a stored recording.

11. The non-transitory computer-readable medium of claim 10, wherein the video conference is one of a plurality of video conferences that are associated with an event, and wherein storing the recording of the video conference further comprises instructions that cause the computing device to:
associate the stored recording of the video conference with the event.

12. The non-transitory computer-readable medium of claim 10, wherein the one or more instructions cause the computing device to:
generate a transcript of the recording of the video conference; and
store the transcript of the recording of the video conference.

13. The non-transitory computer-readable medium of claim 12, wherein the one or more instructions cause the computing device to:
analyze at least one of the recording and the transcript to identify metrics for at least one participant in the video conference, wherein the metrics for each participant comprise one or more of a talking speed, a talk-listen ratio, a filler word rate, a maximum monologue length, and a question-answer delay; and
store the metrics for the at least one participant.

14. The non-transitory computer-readable medium of claim 9, wherein detecting the recording trigger comprises instructions that cause the computing device to:
receive an email from the second service, wherein the email includes information that identifies the video conference and a start time for the video conference;
store the start time for the video conference as the recording trigger for the video conference; and
detect, the recording trigger at the start time for the video conference.

15. The non-transitory computer-readable medium of claim 9, wherein detecting the recording trigger comprises instructions that cause the computing device to:
monitor a calendar of a user of the first service;
detect an appointment in the calendar, wherein the appointment identifies the video conference and a start time for the video conference;
store the start time for the video conference as the recording trigger for the video conference; and
detect the recording trigger at the start time for the video conference.

16. A computing device, comprising:
one or more memories; and
one or more processors, communicatively coupled to the one or more memories, configured to:
detect a recording trigger comprising information that identifies a video conference of a second service for which recording functionality has been requested;
communicate, to an interface client, a first request to provision a recording client, wherein the recording client is a client computing device of a first service that is capable of joining the video conference of the second service;
receive, from the recording client, a second request for video conference parameters, wherein the video conference parameters comprise information that corresponds to the video conference of the second service;
communicate the video conference parameters to the recording client, wherein the recording client is configured to join the video conference of the second service in response to the communicating;
receive information identifying a status of the recording client.

17. The computing device of claim 16, wherein the computing device is configured to:
receive a recording of the video conference from the recording client; and
store the recording of the video conference as a stored recording.

18. The computing device of claim 17, wherein the video conference is one of a plurality of video conferences that are associated with an event, and wherein the computing device is configured to:
associate the stored recording of the video conference with the event.

19. The computing device of claim 17, wherein the computing device is configured to:
generate a transcript of the recording of the video conference; and
store the transcript of the recording of the video conference.

20. The computing device of claim 19, wherein the computing device is configured to:
analyze at least one of the recording and the transcript to identify metrics for at least one participant in the video conference, wherein the metrics for each participant comprise one or more of a talking speed, a talk-listen ratio, a filler word rate, a maximum monologue length, and a question-answer delay; and
store the metrics for the at least one participant.
